(19) United States
(12) Patent Application Publication
(10) Pub. No.: US 2013/0145926 A1
(43) Pub. Date: Jun. 13, 2013

(54) ELECTROHYDRAULIC CONTROL DEVICE

(71) Applicant: Robert Bosch GmbH, Stuttgart (DE)

(72) Inventors: Albert Koeckemann, Lohr (DE); Hermann Mehling, Karlstadt-Stetten (DE)

(73) Assignee: Robert Bosch GmbH, Stuttgart (DE)

(21) Appl. No.: 13/709,408

(22) Filed: Dec. 10, 2012

(30) Foreign Application Priority Data
Dec. 10, 2011 (DE) 10 2011 120 767.1

(51) Int. Cl. F15B 11/042; F15B 11/046

(52) U.S. Cl. CPC F15B 11/0426; F15B 11/046
USPC 91/363 R; 60/464

(57) ABSTRACT

An electrohydraulic control device and a method for actuating such an electrohydraulic control device include a hydraulic consumer having an actuator element and a pressure medium source that is quantity-adjustable. The speed of the actuator element is controlled by the pressure medium source and the position of the actuator is controlled by digital hydraulics.

This application claims priority under 35 U.S.C. §119 to patent application no. DE 10 2011 120 767.1, filed on Dec. 10, 2011 in Germany, the disclosure of which is incorporated herein by reference in its entirety.

### BACKGROUND

The disclosure relates to an electrohydraulic control.

WO 02/086 327 A1 presents an electrohydraulic control device which is embodied as “digital hydraulics”, i.e. as a digital servovalve circuit. Such a control device has a multiplicity of seat valves which are arranged in parallel and can be switched digitally and by which an opening cross section of the digital servovalve circuit is set incrementally as a result of the principle. It is also known to actuate such seat valves in a pulsed fashion with the result that when averaged over time intermediate values can be implemented between the open position and the closed position.

Instead of digital hydraulics of this type, proportional valves which are actuated by a controller are usually used to move an actuator element, for example a hydraulic cylinder. Such proportional valves are suitable for accelerating or braking the actuator element in a stepless fashion so that dynamic speed adjustment of the actuator element is made possible. However, in order to perform fine positioning of the actuator element in solutions with proportionally adjustable valves, a considerable degree of expenditure in terms of devices and control equipment is necessary.

Although this disadvantage can be overcome with the digital hydraulics specified at the beginning, it is problematic here that the control using digital hydraulics also requires a large amount of expenditure to be able to perform adjustment with the necessary dynamics in the case of actuator elements with different oil volumes, for example in the case of a differential cylinder. A further disadvantage of digital hydraulics is a generation of noise by the pulsed switching valves and the associated wear on these components.

In contrast, the disclosure is based on the object of providing an electrohydraulic control device which permits the speed or position to be controlled with low expenditure in terms of devices and control equipment.

### SUMMARY

This object is achieved by means of an electrohydraulic control device having the features of the disclosure.

Advantageous developments of the disclosure are the subject matter of the dependent claims.

According to the inventive concept, an actuator element is actuated during the speed control essentially by means of a quantity-adjustable pressure medium source, while the positioning is performed essentially by means of digital hydraulics.

Specifically, an electrohydraulic control device according to the disclosure has a valve arrangement by means of which pressure medium connections of an actuator element, for example of a hydraulic cylinder or of a hydraulic motor can be connected to a pressure medium source or to a tank. This valve arrangement has a multiplicity of valves with a switching characteristic which can be actuated in a pulsed fashion by means of a controller. According to the inventive concept, the pressure medium source is of quantity-adjustable design and the valve arrangement is embodied in such a way that in each case one outflow valve is assigned to at least two connections of the actuator element. A fluid connection between the respective connection and the tank is controlled by means of such an outflow valve.

According to the disclosure, the controller has a setpoint value input to which a setpoint value signal for a speed and/or a position of the actuator element can be fed. Furthermore, a position transducer for sensing a position of the actuator element is assigned to the controller, the position signal of which position transducer is fed to an input of the controller. Said controller also has an output predefining a pressure medium quantity to the pressure medium source, wherein the controller forms an adjustment signal from the signal at the setpoint value input and the position signal. Said adjustment signal corresponds essentially to a speed presetting of the hydraulic consumer/actuator element.

According to the inventive concept, the controller has a logic circuit which feeds either a pulsed actuation signal formed from the adjustment signal or a predefined actuation signal to at least one outflow valve, and which logic circuit feeds either an actuation signal formed from the adjustment signal or a predefined actuation signal to the pressure medium source. As a result of this circuit it becomes possible, for example, firstly to move the actuator element with the predefined speed by a suitable actuation of the pressure medium source, and then an approximation to the predefined setpoint position occurs to switch over said actuator element by means of the logic circuit in such a way that the outflow valve is actuated in a pulsed fashion by means of the predefined actuation signal.

In one exemplary embodiment of the disclosure there is provision to embody the logic circuit in such a way that a predefined actuation signal is fed to at least one outflow valve, and the actuation signal which is formed by the adjustment signal can be fed to the pressure medium source.

In an alternative solution, the logic circuit is configured to feed a predefined actuation signal to the pressure medium source, while said logic circuit feeds a preferably pulsed actuation signal formed from the adjustment signal to at least one outflow valve.

In a further alternative there is provision that the logic circuit is embodied in such a way that it feeds a predefined actuation signal to the pressure medium source, while said logic circuit feeds a pulsed actuation signal formed from the adjustment signal to at least one inflow valve.

In an advantageous variant of the control device there is provision that each connection of the actuator element or of the consumer is assigned an inflow valve which controls a fluid connection between this connection and the pressure medium source.

Such a control device and such a method for actuating a control device permit an actuator element to be adjusted with high dynamics, and in the case of switching over to the control by means of the digital hydraulics permit precise positioning, wherein the advantages of the prior art stated at the beginning are combined and the disadvantages, i.e. a large generation of noise during the speed control and costly position control by means of proportionally adjustable elements are overcome.

In one exemplary embodiment of the disclosure, the acceleration and the speed are controlled essentially by actuating the pressure medium source, and the positioning and possible braking processes of the actuator element are controlled essentially by actuating the valve arrangement (digital hydraulics), wherein, of course, mixed forms with actuation of the pressure medium source and simultaneous actuation of the digital hydraulics are also possible.

The valves of the valve arrangement are preferably embodied as switchable seat valves or slider valves, such as are described, for example, in WO 02/086324 A1.

In one exemplary embodiment of the disclosure, the valve arrangement is arranged with a plurality of switching valves in a common valve housing.

In one preferred exemplary embodiment, the valves of the valve arrangement behave ballistically, i.e. the valve piston opens in short pulses without reaching its upper end position and then drops back to the valve seat. In the case of relatively long switch-on pulses, the valve piston reaches its upper end position and drops back after a short dwell time. This corresponds approximately to pulse width modulation of the opening cross section or of the averaged through-flow of the fluid. Given even longer switch-on periods, the valve can behave in an inversely ballistic fashion, i.e. during the switch off time the piston then only drops briefly back in the direction of the seat but does not reach it anymore. Such ballistic operation is known, for example, from DE 102 24 689 A1, with the result that further explanations in this regard can be dispensed with.

In one variant of the disclosure, the actuator element is embodied as a hydraulic cylinder having two pressure spaces which are each connected to the pressure medium source via one of the inflow valves, and to a tank or a return line via one of the outflow valves.

The pressure medium source may be embodied, for example, as an adjustment pump or as a rotational-speed-variable constant pump.

The valves of the valve arrangement can be actuated according to pulse width modulation (PWM). The pulse width modulation can take place here with a frequency which is 0.5-1.0 times the maximum switching frequency of the respective valve.

In one exemplary embodiment, the pressure medium source is embodied with a subordinate volume flow control circuit or with a subordinate pressure control circuit.

In a further exemplary embodiment of the disclosure, pressure pickups are used to sense the pressures at the connections of the actuator element and at the output of the pump. The signals of these pressure pickups are signaled to corresponding actual value inputs of the controller.

The position of the actuator element can be sensed by means of a position transducer.

### BRIEF DESCRIPTION OF THE DRAWINGS

Preferred exemplary embodiments of the disclosure are explained in more detail below with reference to schematic drawings, in which:

FIG. 1 shows a switching diagram of a control device according to the disclosure and of a variant of a control device of this type, and

FIG. 2 shows a diagram explaining the control concept according to the disclosure.

### DETAILED DESCRIPTION

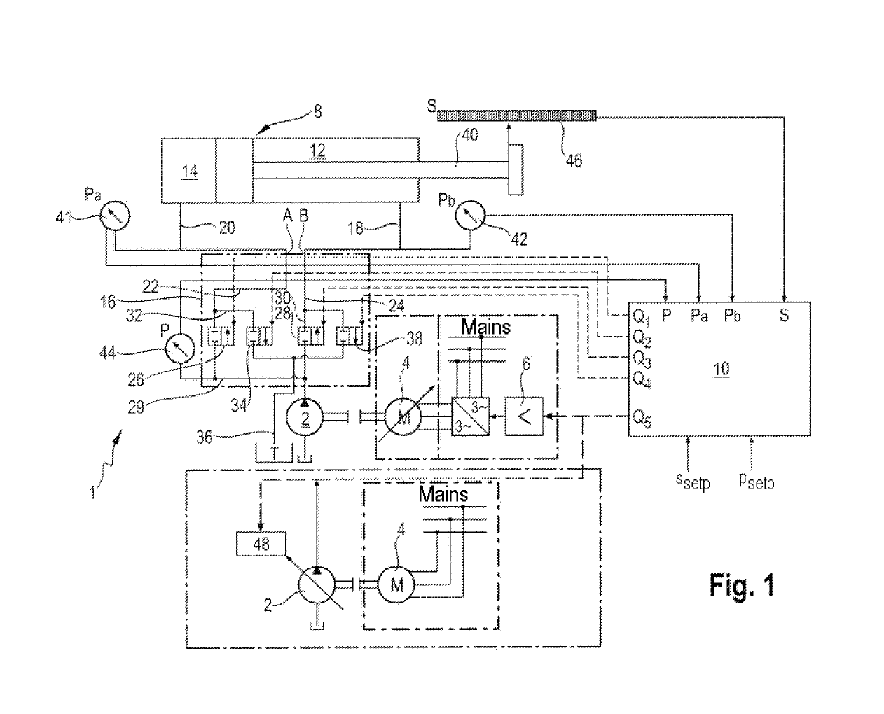

According to the illustration in FIG. 1, an inventive electrohydraulic control device 1 has a pressure medium source, in the present case a rotational-speed-controlled constant pump 2, the rotational speed of the motor 4 of which is controlled by means of a rotational speed controller 6 in order to control the pressure medium volume flow, with the result that a consumer, in the present case a hydraulic cylinder 8, can be moved at a predefined speed. As long as this hydraulic cylinder 8 is moved at a constant speed, the pressure at the pressure connection of the pump can also be controlled by means of the rotational speed controller 6. That is to say the pressure/delivery rate of the pump 2 is controlled.

The rotational speed controller 6 is actuated by means of a controller, referred to below as motion controller 10, by means of which the rotational speed controller 6 is actuated according to the setpoint values for the position sₛₑₜₚ and/or the speed vₛₑₜₚ of the hydraulic cylinder 8, or the pressure pₛₑₜₚ of the pump. These setpoint values are calculated, for example, as a function of a speed presetting which is set, for example, by means of a joystick or the like.

In accordance with these setpoint values, a pressure medium volume flow requirement Q₅ is output by the motion controller 10 to the rotational speed controller 6 as a setpoint value, and a corresponding rotational speed of the motor 4 and therefore of a delivery volume flow of the pump 2 is set by means of said motion controller 10.

The hydraulic cylinder 8 has a piston-rod-side annular space 12 and a bottom-side annular space 14 which can be connected to the pressure connection of the pump 2 or to a tank T via a valve arrangement 16 which is indicated by dot-dashed lines. The electrohydraulic control device 1 is therefore embodied as an open circuit. The valve arrangement 16 can be combined in a single housing to form one structural unit.

Each pressure space 12, 14 is connected to a working connection A, B of the valve arrangement 16 via a working line 18 or 20, which valve arrangement 16 has, itself, a pressure medium connection to two line sections, which are referred to below as inflow 22 and outflow 24, wherein, depending on the switching position of the valve arrangement 16, the “inflow 22” can also serve as the outflow, and the “outflow 24” can correspondingly serve as the inflow. In the inflow 22, an inflow valve 26 is arranged which is embodied in the illustrated exemplary embodiment as a 2/2 switching valve of a slider design. In principle, this switching valve can also be embodied as a seat valve.

The inlet of the inflow valve 26 is then connected to a pump line 26 which is connected to the pressure connection of the pump 2. A branch of this pump line 28 is connected to the inlet of a further inflow valve 28, the output connection of which is connected to an inflow line 30 which opens into the outflow 24. The two valves 26, 28 are of identical design.

Branching off from the inflow 22 downstream (in the direction of pressure build up) is an outflow line 32 which is connected to the inlet connection of a further 2/2 way valve which is referred to below as an outflow valve 34. The outlet connection of which is connected to a tank line 36. A branch of this tank line 36 is connected to the outlet of a further outflow valve 38, the inlet connection of which is connected to the outflow 24.

Two outflow valves 34, 38 are also embodied as 2/2 way valves with a switching characteristic. These switching valves can be activated electrically or electrohydraulically and, according to the illustration in FIG. 1 are prestressed into their off position by means of a spring (not illustrated) in the de-energized state.

According to the embodiments, each pressure space 12, 14 is assigned an inflow valve 26, 28 and an outflow valve 34, 38.

These switching valves can be switched with high dynamics and are configured for use in digital hydraulics. In this context they can be embodied with what is referred to as a “booster”, a valve booster for more rapid switching. Such valves are known from the prior art, and further explanations can therefore be dispensed with. The switching over of the valves is carried out by means of the motion controller 10, wherein a control signal Q₁, Q₂, Q₃, Q₄ is output to the switching valves 26, 34, 28, 38 for the adjustment thereof in accordance with the actual position s of a piston rod 40 of the hydraulic cylinder 8 and the desired setpoint position sₛₑₜₚ. These valves are actuated in accordance with pulse width modulation (relatively long switch-on pulses) or in the case of relatively short switch-on pulses in such a way that the valve piston does not reach its upper end position (opening) (ballistic behavior). In order to implement such ballistic behavior, the motion controller 10 is embodied with a device for generating control pulses with a variable time period, wherein this time period is dimensioned such that a valve, actuated therewith, of the valve arrangement carries out an opening stroke out of the closed position, but drops back into the closed position without reaching its completely switched open position or, wherein the time period of the control pulses is dimensioned such that a valve, actuated therewith, of the valve arrangement carries out a closing stroke out of its completely switched open position, but is switched back into the open position without reaching the completely closed position (inverse ballistic).

The pressure in the working lines 18, 20 is sensed by means of two pressure pickups 41, 42. A third pressure pickup 44 serves to sense the pressure in the pump line 29.

The signal of these pressure pickups 41, 42, 44 is sent to the motion controller 10 as an actual value P, Pa and Pb via a corresponding signal line.

The stroke s of the piston rod 40 is sensed by means of a position transducer 46 and, as explained, is sent as an actual position s to the motion controller 10.

The motion controller 10 has a logic circuit (not illustrated) by means of which, for example, an adjustment signal is formed from the setpoint value for the position and/or the speed of the actuator element and the position signal sensed by means of the position transducer 46, which adjustment signal then corresponds essentially to the speed presetting of the hydraulic cylinder 8 or the piston rod 40 thereof. The pressure medium source is then actuated as a function of the actuation signal formed from the adjustment signal or by means of a predefined actuation signal. For example, when approximation to a setpoint position occurs or when the consumer is started up, the pressure medium source can be actuated as a function of a predefined actuator signal, while the respective outflow valve or inflow valve is actuated in a pulsed fashion as a function of an actuation signal formed from the adjustment signal. Put simply, by means of the logic circuit it is decided, as a function of the state of movement or the position of the respective hydraulic consumer, whether the pump 2 or an inflow valve or outflow valve is actuated in order to move the consumer at the predefined speed or in the region of the predefined position. The respective other switching element (pressure medium source or inflow/outflow valve is then actuated according to a predetermined actuation signal. It is therefore possible, for example, for the outflow valve to be opened completely during the control of the pressure medium source, and in a converse fashion the pressure medium source can be operated under pressure control during the pulsed actuation of the outflow/inflow valve.

The pressure medium source can be embodied with a subordinate volume flow control circuit and/or a subordinate pressure control circuit.

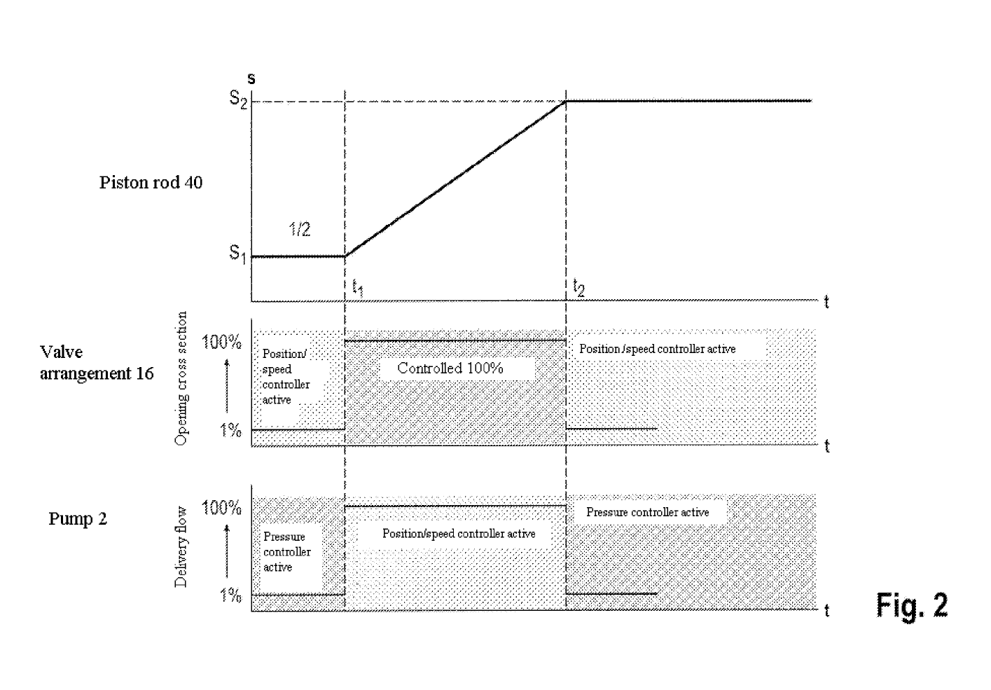

The inventive control concept will be explained with reference to the diagram in FIG. 2.

FIG. 2 shows at the top the desired stroke s of the piston rod 40 plotted against the time t. Accordingly, during a first time interval t₁ a comparatively small stroke s is to be kept constant. Within a time interval t₁-t₂, the piston rod 40 is then extended to a stroke s₂ at a constant speed, and is then held in this position.

In the two diagrams lying below this stroke curve, the control behavior of the valve arrangement 16 is illustrated, and below it the control behavior of the pump 2.

Accordingly, in order to secure the first stroke s₁ in the time interval t₁ by means of the logic circuit of the motion controller 10, the valve arrangement 16 is actuated with the respectively active inflow valve 26 or 28 and the outflow valve 34 or 38, respectively located correspondingly in the outflow, in such a way as to keep the position of the piston rod 40. During this positional control by means of the valve arrangement 16 (digital hydraulics), the described pressure control of the pump 2 is active.

In order to extend the piston pump 40 to the stroke s₂, the valves in the inflow and the outflow are completely opened by means of the logic circuit, and the delivery flow of the pump 2 is controlled by means of the motion controller 10, and the piston rod 40 is therefore extended with the predetermined speed.

When the setpoint position s₂ is reached, the pump 2 is in turn switched over to pressure control, and the position/speed control of the piston rod is performed by means of the digital hydraulics with the valve arrangement 16. That is to say in order to approach the setpoint position s₂ and to hold this setpoint position, the valves 26, 28, 34, 38 of the valve arrangement 16 are actuated according to pulse width modulation and/or a ballistic behavior, with the result that the setpoint position is held with a high degree of precision.

In FIG. 1, a variant of the previously described exemplary embodiment is explained with the dot-dash box inserted at the bottom. In this context, instead of a rotational-speed-controlled pump 2, an adjustment pump 2 is used, wherein the pressure/delivery flow control is carried out by means of a pump controller 48 which adjusts, for example, a pivoting angle of a swash plate of an axial piston pump. The motor 4 of this pump can be operated here at a constant rotational speed. The control behavior which is explained with reference to FIG. 2 can also be implemented with such a variant.

An electrohydraulic control device and a method for actuating such an electrohydraulic control device are disclosed, wherein, for example, the speed is controlled by means of a quantity-adjustable pressure medium source and the positioning is controlled by means of digital hydraulics.

### LIST OF REFERENCE NUMERALS

1 Control device

2 Pump

4 Motor

6 Rotational speed controller

8 Hydraulic cylinder

10 Motion controller

12 Annular space

14 Pressure space

16 Valve arrangement

18 Working line

20 Working line

22 Inflow

24 Outflow

26 Inflow valve

28 Inflow valve

29 Pump line

30 Inflow line

32 Outflow line

34 Outflow valve

36 Tank line

38 Outflow valve

40 Piston rod

41 Pressure pickup

42 Pressure pickup

44 Pressure pickup

46 Position transducer

48 Pump controller

What is claimed is:

1. An electrohydraulic control device for activating an actuator element of a hydraulic consumer, comprising:
one or more of a pressure medium source and a tank, the pressure medium source being quantity-adjustable;
a controller having a setpoint value input for one or more of a speed and a position of the actuator element;
a valve arrangement having valves with a switching characteristic, the valves being actuated in a pulsed fashion by the controller;
a plurality of pressure medium connections configured to be connected via the valve arrangement to the pressure medium source or the tank, the valve arrangement being embodied in such a way that each connection is assigned at least one outflow valve that controls a fluid connection between this connection and the tank; and
a position transducer configured to sense the position of the actuator element and generate a corresponding position signal to be applied to the controller, the controller having an input configured to receive the position signal and an output configured to predefine a pressure medium quantity to the pressure medium source,
wherein the controller forms an adjustment signal from the signal at the setpoint value input and the position signal that corresponds essentially to a speed presetting of the hydraulic consumer, and
wherein the controller has a logic circuit which feeds (i) either a pulsed actuation signal formed from the adjustment signal or a predefined actuation signal to at least one outflow valve and (ii) either an actuation signal formed from the adjustment signal or a predefined actuation signal to the pressure medium source.

2. The control device according to claim 1, wherein the logic circuit is configured to feed a predefined actuation signal for at least one outflow valve while said logic circuit feeds the actuation signal formed from the adjustment signal to the pressure medium source.

3. The control device according to claim 1, wherein the logic circuit is configured to feed a predefined actuation signal to the pressure medium source while said logic circuit feeds a pulsed actuation signal formed from the adjustment signal to at least one outflow valve.

4. The control device according to claim 1, wherein the logic circuit is configured to feed a predefined actuation signal to the pressure medium source while said logic circuit feeds a pulsed actuation signal formed from the adjustment signal to at least one inflow valve.

5. The control device according to claim 1, wherein the valve arrangement is designed in such a way that each connection is assigned an inflow valve which controls a fluid connection between this connection and the pressure medium source.

6. The control device according to claim 1, wherein an acceleration, a speed, and, if appropriate, a pressure are controlled essentially by actuating the pressure medium source, and wherein the positioning and the braking processes are controlled essentially by actuating the valve arrangement.

7. The control device according to claim 1, wherein the valves of the valve arrangement are seat valves or slider valves.

8. The control device according to claim 1, wherein the valve arrangement is arranged in a common valve housing.

9. The control device according to claim 1, wherein the valves of the valve arrangement are actuated according to pulse width modulation.

10. The control device according to claim 1, wherein the valves of the valve arrangement are actuated ballistically.

11. The control device according to claim 1, wherein the actuator element is a hydraulic cylinder having two pressure spaces that are each configured to be connected to the pressure medium source via one of the inflow valves and to the tank via one of the outflow valves.

12. The control device according to claim 1, wherein the pressure medium source is embodied as an adjustment pump or as a rotational-speed-variable constant pump.

13. The control device according to claim 1, further comprising pressure pickups configured to sense the pressure at the output of the pressure medium source or at the actuator element.

14. The control device according to claim 13, wherein the pressure medium source has volume flow control and pressure control.

15. The control device according to claim 1, wherein the pressure medium source has one or more of a subordinate volume flow control circuit and a subordinate pressure control circuit.
